(19) United States
(12) Patent Application Publication
(10) Pub. No.: US 2005/0067270 A1
(43) Pub. Date: Mar. 31, 2005

(54) Switch with a thermoprotection

(75) Inventor: Antonio Coppola, Turate (IT)

Correspondence Address: ARENT FOX KINTNER PLOTKIN & KAHN, PLLC, Suite 600, 1050 Connecticut Avenue, N. W., Washington, DC, 20036-5339, US

(73) Assignee: SIGNAL LUX MDS S.r.l.

(21) Appl. No.: 10/716,706

(22) Filed: Nov. 20, 2003

(30) Foreign Application Priority Data
Sep. 30, 2003 (EP) 03425641.2

(51) Int. Cl. H01H 9/20

(52) U.S. Cl. 200/334

(57) ABSTRACT

A safety switch, in particular for thermal protection of an electrical apparatus, comprises a container inside which means for activation of said switch is housed, said means comprising a command key and a pair of contact carriers, that are movable and fixed respectively, and a thermoprotector device responsive to temperature variations in the environment to be controlled and adapted to act on the electric supply circuit of said apparatus depending on the perceived heat level. Said movable contact carrier oscillates between two positions, an open position at which said contact carriers are separated from each other and respectively a closed position, at which said contact carriers are in mutual contact, each of said positions being imposed by a corresponding position of said command key. The thermoprotector device acts in case of need on the electric supply circuit and separates the contact carriers from each other by forcing the command key to the open position. This action deactivates the thermoprotector device and the switch therewith, and a new activation of the latter can only take place by exerting a pressure on the command key capable of bringing the key again to the closed position and set the thermoprotector again ready for operation.

### FIELD AND BACKGROUND OF THE INVENTION

The present invention relates to an electric safety switch and, more particularly to a switch for electrical apparatus for which a permanent stopping is required to be ensured, but that can be drivingly put again in service in all cases of wrong use of the apparatus or malfunction of the apparatus itself or of the switch, or in case of unforeseen or predetermined change of the thermal situation of the environment controlled by said switch.

For better understanding of the technical problem tackled by the invention it is to be considered first of all an electric motor failing to properly function due to mechanical inconveniences (seizure of the bearings, for example) or electrical inconveniences (a short-circuited winding) hindering or inhibiting rotation of same.

These motors are protected by a safety device, also known as a remote control switch, generally consisting of a pair of metal plates inserted in the supply circuit and usually mutually closed. On passage of an electric current of a higher intensity than the preestablished one, the plates mutually separate and deform by Joule effect, thereby breaking the supply circuit. As temperature comes back to its usual value the plates approach again and power to the motor is restored.

In the above assumed case, by putting the switch in service the motor is powered but, due to its being restrained from rotating, the intensity of the supply current running through the circuit increases until the predetermined threshold value is overcome. Intervention of the remote control switch puts the motor out of service until cooling of said plates, the motor being then automatically put again in service. If this malfunction is not detected by an operator, a series of interventions of the remote control switch occur that cyclically put the motor in service and out of service. However, these continuous current pulses of high intensity cause heating of the electric circuits of the motor and, by conduction or convection, of the devices connected therewith too, such as the switch and remote control switch, which is dangerous for the physical integrity of same. Practically, interventions of the remote control switch go on until physical destruction (by melting for example) of the latter or any other part of the apparatus.

It may also happen that the repeated opening and closing cycles of the contacts in the remote control switch cause locking of the remote control switch itself due to welding between the contact points of the plates, as a result of the electric arc taking place between said points at each opening and closing movement of the contact.

Due to this inconvenience, since the motor is always powered, an irreparable damage to the apparatus itself is caused so that said apparatus needs to be replaced and there is also a serious risk for the machine operator's safety.

The case is now contemplated in which a motor planned for an intermittent use is on the contrary utilized in a continuous service. In this case the supply current will never overcome the predetermined threshold value so that intervention of the remote control switch is never required. However the corresponding Joule effect heats the different parts of the apparatus, many of which are made of plastic material with a low melting point that hardly bears overheating due to such a use, so that temperature is brought to damaging and dangerous levels. As a consequence, a quick out-of-use of the apparatus is obtained which will involve expenses for servicing, repair and replacement of the damaged parts.

The case of a heating apparatus, an oil radiator or an electric heater is finally taken into account: these apparatus are provided with an electric resistance heating an intermediate fluid (oil) or directly heating the environmental air and are controlled by a thermostat starting and shutting off the supply circuit of the electric resistance depending on the result of a comparison between the temperature set on the thermostat and the ambient temperature.

If a cloth (towel, linen, duster) is accidentally or intentionally placed on the heating apparatus, against the constructor's instructions or regulations, this cloth will hinder spreading of heat generated by the electric resistance towards the surrounding environment causing an important rise in the temperature of the environment confined between the cloth and the stove. If the thermostat is inserted in the stove, as it usually happens, it feels the temperature rise and breaks the electric supply circuit, but the electric resistance and the materials connected therewith go on giving heat off over a certain period of time causing a further rise in the temperature level in the stove and the space included between the stove and the cloth. When temperature then goes down, the thermostat closes the electric circuit giving rise to a new heating cycle. In this case too, the continuous thermal cycles damage the weakest parts of the stove in an irreparable manner.

It is to be pointed out that none of the control and/or protection devices known, thermocouples, remote control switches, thermostats for example, are able to eliminate these drawbacks. There are already on the market safety switches that in case of malfunction of the protected apparatus definitively stop the electric supply circuit but this interruption takes place with destruction of the switch. This expedient involves costs and periods of machine stop for replacement of the destroyed piece and is therefore uneconomic and too drastic in the cases in which a malfunction, if identified in due time, could be easily eliminated thereby avoiding the consequent damages.

Through examination of the mentioned cases the Applicant has become aware of the fact that there is a technical problem consisting in that all known protection devices act on the supply current of the electric circuits as a primary source of heat production but do not consider the effect resulting from heat accumulation, possibly also in the absence of electric power.

The Applicant has perceived that the identified technical problem could be solved with a device of a new type, capable of simultaneously ensuring full safety, functional character, reliability and low cost, which is adapted to act on the electric supply circuit of an apparatus depending on the perceived heat level, carrying out a single automatic intervention on said circuit with subsequent stopping of the device, with the possibility however of restoring operation of the device itself in a non-automatic manner after each intervention.

### SUMMARY OF THE INVENTION

Accordingly, the invention relates to a safety switch, in particular for supply circuits of electric machines, comprising the features set out in the characterizing portion of claim 1 and in the claims depending thereon.

More specifically, the invention relates to a safety switch, in particular for thermal protection of an electrical apparatus, comprising a container inside which means for activation of said switch is housed, said means comprising a command key and a pair of contact carriers, movable relative to each other, each of them being connected with a terminal of its own of an electric circuit, at least one of said contact carriers being swingable between two positions, an open position at which said contact carriers are separated from each other and respectively a closed position, at which said contact carriers are in mutual contact, each of said positions being imposed by a corresponding position of said command key, said switch being characterized in that said activation means comprises a (thermoprotector) device responsive to temperature variations in the environment to be controlled and adapted to act on the electric supply circuit of said apparatus depending on the perceived heat level, carrying out a single action on said circuit, the possibility of reuse of the device after said action being bound to the intervention of an operator.

### BRIEF DESCRIPTION OF THE DRAWINGS

Further features and advantages of the invention will become more apparent from the detailed description of a preferred but not exclusive embodiment of a switch in accordance with the present invention. This description will be taken hereinafter with reference to the accompanying drawings given by way of non-limiting example, in which:

FIG. 1 shows a pair of switches, of which at least one is in accordance with the invention, that are inserted in a single support plate and seen in front view from the command side;

FIG. 2 shows a switch in accordance with the invention, seen in cross section along the plane II-II in FIG. 1, in an active position and with a thermal protector hooked thereto;

FIG. 3 shows the switch in FIG. 2, in a passive position and with a thermal protector hooked thereto;

FIG. 4 shows the switch in FIG. 2 in a situation of fault of the system in a passive position and with a thermal protector unhooked therefrom.

### DESCRIPTION OF THE PREFERRED EMBODIMENT

In the present description longitudinal direction stands for the direction of the key displacement plane, transverse direction stands for that of the oscillation axis of the movable contact carrier, radial direction stands for the direction perpendicular to the plane containing said longitudinal and transverse directions.

In a preferred embodiment, the switch of the invention comprises (FIG. 2) an open container 1, of insulating material, preferably a plastic material, within which means 2 for activating said switch is housed. Said means preferably comprises a command key 3, a pair of contact carriers 4 and 5, at least one of which is movable with respect to the other, said movement being controlled by said key 3, and a thermoprotector device 6. Said key 3, in a manner known by itself, preferably has a T-shaped conformation, where the “T” arms 3a, 3b are extended in a longitudinal direction and the “T” leg 3c in a radial direction; it rotates in a longitudinal direction, in the two ways around a transverse rotation axis R-R, passing through the “T” leg and parallel to said oscillation axis.

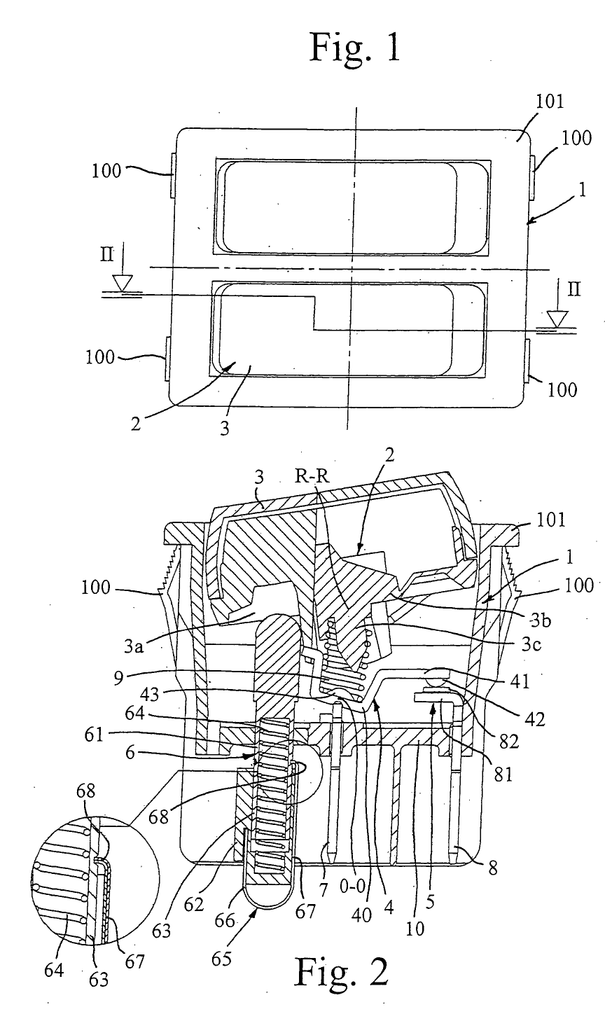

The container, on its outer side surface, is preferably provided with devices 100 enabling easy mounting of same, by restrained fixing, in a corresponding window formed in a side of the apparatus for which it is intended. Along its open edge the container has a flange or plate 101 for coupling by abutment against said wall of the apparatus. Such a flange performs an aesthetic function as well, to make the outer appearance of the switch agreeable (FIG. 1) and also has a functional character as it carries graphic symbols such as the constructor's name or trademark and information about the position of key 3.

Provided inside the container is a separating baffle 10 which is substantially oriented as the flange and will be hereinafter defined as the container floor: inserted in said floor is a pair of electric terminals 7, 8, referred to as first 7 and second 8 terminals respectively, for connection with the electric circuit controlled by the switch.

Preferably said pair comprises two plates 7, 8 of electrically conductive material, projecting from said floor and facing said key. Said plates preferably also project externally of the container, coming out of the container floor: these projecting portions, in use, are connected to corresponding lead-in wires (not shown) of the conductors of the electric system to be controlled.

Plate 7 constitutes a laminar support for the movable contact carrier; more preferably the plate end 7 extended within the container, acts as a fulcrum for said contact carrier, and oscillates like a rocking lever around said fulcrum in a transverse oscillation axis O-O, parallel to axis R-R.

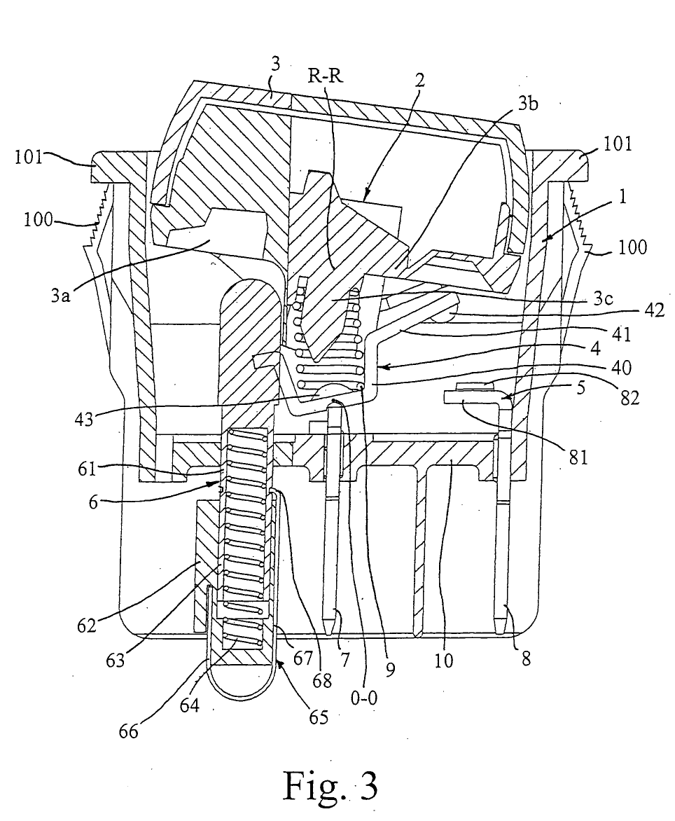

Preferably, the oscillating contact carrier 4 (FIG. 3) comprises a tilting contact element 40 of a U-shaped configuration the base of which rests on said fulcrum and at least one of the two sides of which is provided, at the free end thereof, with a flange 41 projecting in cantilevered fashion from said end and extended in a longitudinal direction, away from the oscillation axis. Fastened to this flange is an electric contact point 42 preferably consisting of a drop of a suitable conductive material, welded onto the surface of said flange. More particularly, the contact point 42 is fastened to the surface of flange 41 facing the floor.

Plate 8 projects internally of the container at flange 41: preferably, the free end of the plate is associated with a flange 81, or is bent in the form of an “L” so as to form said flange, projecting in cantilevered fashion from the body of said plate 8 and extending in a longitudinal direction towards the oscillation axis O-O. Fastened to this flange is an electric contact point 82 preferably consisting of a drop of suitable conductive material, welded onto the flange surface. More particularly, the contact point 82 is fastened to the surface of flange 81 facing the key. In this way the contact points 42 and 82 always face each other, in mutual register.

Resting on the base surface of said “U”, i.e. of the tilting contact element 40, facing the key is the end of a first helical spring 9 having the opposite end fitted in the key leg 3c, in abutment against the arms of said key. Preferably the spring end resting on the base of the tilting contact element is maintained in place by a relief 43 in the form of a spherical cap radially projecting from said base towards the outside.

The length of spring 9 is slightly bigger than the distance between the key arms and the base of the tilting contact element, so that said spring is compressed and in an unstable equilibrium in a straight configuration. Consequently it arranges itself in a curvilinear trajectory exerting a corresponding thrust on key 3 and on the tilting contact element 4: this thrust constrains said elements to a predetermined position relative to the longitudinal direction. In particular it locks the movable contact carrier 4 relative to the other contact carrier 5, either in a closed position for example, i.e. of mutual contact (FIG. 2), or in an open position, i.e. of mutual separation (FIG. 3). A convenient pressure exerted on the key surface reverses the spring curvature and consequently the mutual position of the two contact carriers. The contact carrier 5 was described and illustrated as a fixed contact carrier for the sake of simplicity in terms of explanation and representation, however in other alternative embodiments of the invention this contact carrier too can be movable and in particular it can oscillate around a corresponding fulcrum.

In accordance with the invention, the switch now described is provided with a thermoprotector device 6 comprising an element 61 alternately and elastically movable between and active position and a passive position, of non-interference and interference respectively with at least one of said activation means 3, 4 and 5, said element 61 being held in said active position by locking means 65 responsive to temperature variations, adapted to release said element 61 taking it to a passive position and locking it to said position, by effect of a predetermined temperature variation, said element 61 in said passive position locking said activation means 3 and/or 4 and/or 5 to one of said open or closed positions of said contact carriers.

In other words, the thermoprotector device 6 is substantially made up of a thermocouple for control of the temperature in a predetermined environment, which thermocouple when a threshold value, which is also predetermined, of said temperature is reached, activates a release device reversing the mutual position of the two contact carriers in a permanent manner.

In a preferred embodiment of the invention, element 61 comprises a tubular preferably cylindrical case 62, rigidly connected to the switch casing which contains a hollow rod 63 freely slidable within said tubular case, in both ways, between a contracted position and an extracted position; this telescopic movement, in a radial direction, through floor 10, urges said rod 63 towards said key 3, preferably at one of said arms 3a, 3b.

Housed in the cavity of rod 63 is a second spring 64 working under compression which is disposed between the case base and the rod ceiling, to extract said rod at least partly from said case and urge it against said key. The spring 64 which is compressed when the thermoprotector is in an active position, supplies energy to overcome the resistance of the first spring 9 when the rod 63 must change position of key 3 and/or of the contact carrier 4.

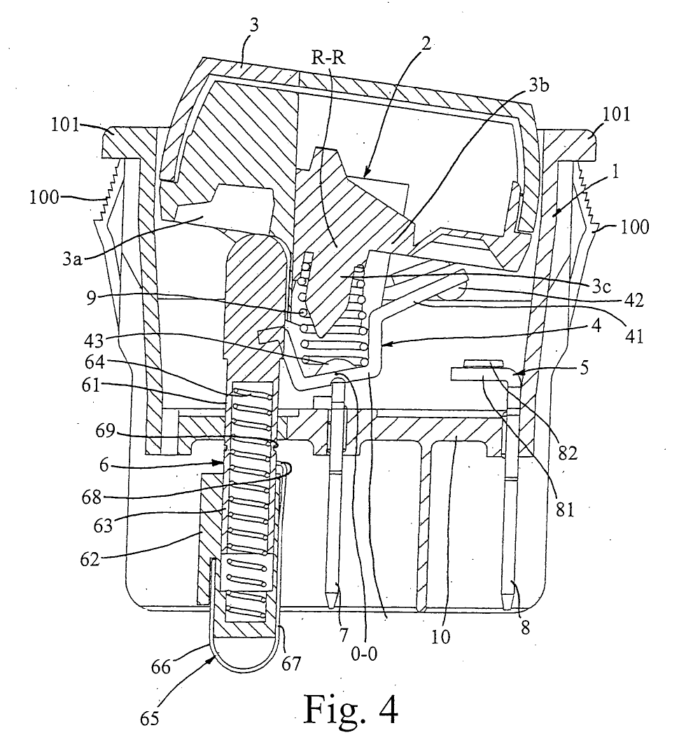

Preferably said locking means 65 comprises a thermocouple 66 disposed on the body of the tubular case 62 and rigidly connected therewith, which externally projects from the container casing and is provided with a laminar portion 67 extended along the rod and having the free end formed with a stop pawl 68 adapted to be inserted in a corresponding notch 69 (FIG. 4) formed in the wall of said rod, so as to lock the rod in a contracted position with the spring 64 under compression.

Preferably said thermocouple has an elongated lamelliform shape rigidly connected, at one end, with said case and extended along the side surface of said rod, the opposite end of said laminar portion 67 being bent at an angle against said surface to form said stop pawl 68.

Preferably, notch 69 comprises a continuous annular throat extending on the side surface of rod 63: this solution avoids rod 63 being restrained from rotating on its own axis in order to always ensure coupling between pawl 68 and notch 69.

Operation of the switch takes place as follows.

FIG. 2 shows the switch of the invention in a first position herein defined as closed position. Under this situation flange 41 of the contact carrier 4 is inclined to the container floor, the contact carrier 4 and contact carrier 5 being in mutual contact; the electric supply circuit of the apparatus is closed. Rod 63 of the thermoprotector is in a contracted position, hooked by the stop pawl 68 of thermocouple 65 and it does not interfere with the command-key 3.

If it is wished to turn the apparatus off (FIG. 3) it is sufficient to exert a convenient pressure on the radially external surface of the key. This pressure, that can be exerted alternately in the two end positions, causes rotation of key 3 around the transverse rotation axis R-R. Said key rotation changes the inclination of the key arms and therefore reverses the curvature of spring 9 inserted between the arms and the tilting contact element towards the longitudinally opposite direction: consequently spring 9 forces the tilting contact element 40 to longitudinally swing on its own fulcrum.

By effect of this change of inclination the switch takes a position defined as an open position through separation of contact carrier 4 from contact carrier 5, thereby opening the supply circuit of the apparatus. The thermoprotector is always in an active condition with the rod in a contracted position. Rotation of the key moves the key arm away from the rod head, so that the rod cannot interfere with said rotation. Under normal conditions the switch works in the same manner as in the absence of the thermoprotector.

If it is assumed that while the apparatus is working (FIG. 2) the thermocouple detects a temperature rise in the environment where it is housed that is higher than the predetermined value, by effect of this temperature rise the laminar portion 67 of the thermocouple bends and the stop pawl 68 is drawn from notch 69.

FIG. 4 shows the just described situation. The rod 63, that is no longer retained by the stop pawl, is pushed by spring 63 against the arm of key 3 forcing it to reverse its position and the associated position of the contact carrier 4, thereby bringing the switch from the closed to the open position, and deactivating the supply circuit.

As can be seen, the switch of the invention is now locked: in fact, a temperature reduction does not succeed in producing a reverse rotation of the key, so as to close the supply circuit again, because the thermocouple is not structured for carrying out this operation. Even after cooling, the stop pawl provided on the free end of the laminar portion 67 of the thermocouple is not able to hook the rod 63 again. Only an appropriate pressure exerted on key 3 by an operator can overcome the resistance of the spring 64 bringing the rod back to a contracted position, thereby enabling the stop pawl to be inserted again in notch 69 so as to lock the thermoprotector to an active position, ready for a new intervention.

Obviously, at this point, the operator after finding out the reason of the thermoprotector intervention will have done the necessary to eliminate the cause of said intervention (bad operation or malfunction of the apparatus, for example).

At all events, until reset of the switch by said operator, the switch keeps turned off so that the apparatus is protected against further damages and inconveniences.

A person skilled in the art will be able to conveniently select the sizes and type of material of the elements forming the switch and in particular the thermoprotector device in order to control the time values, as well as the current intensity and temperature values causing intervention of the thermoprotector device.

The invention has a great number of advantages.

First of all, intervention of the thermoprotector takes place for a temperature increase of a predetermined value, therefore also independently of the current passage in the controlled circuit. Taking into consideration the cases of a stove and of a short-circuited motor mentioned at the beginning, the remote control switch intervention or the thermostat intervention take place immediately turning the power off from the supply circuit, but this does not inhibit a further heat generation within the apparatus. The thermoprotector device detects this heat generation but its intervention that may take place with some delay with respect to intervention of said thermostat and remote control switch definitively breaks the supply current so that when the thermostat and/or remote control switch restore the electric contact, the apparatus is in any case switched off until intervention of the operator.

The switch has been described showing a condition of open circuit after intervention of the thermoprotector but obviously depending on the type of the controlled circuit, the circuit could move from an open to a closed condition: in particular, said switch activating means when the thermoprotector is in a passive position, can activate a signaling and/or alarm device.

The thermocouple has been described as adjacent to the thermoprotector but, actually, the release device including the laminar portion or lamella 67 with the stop pawl 68 could be operated by a sensor placed in an environment different from that where the switch is housed, thereby enabling a remote control of said environment.

Intervention of the thermoprotector does not destroy the switch itself but puts it in a locked position that can be deactivated by an action carried out by an operator which is not automatic but conscious, said action enabling the thermoprotector to be set again ready for operation, and the switch operation to be restored after each locking event.

The switch of the invention on the whole is of reduced sizes, simple, reliable and inexpensive, with characteristics minimizing the possibility of faults for the switch and prolonging duration of same in time: it mostly comprises mechanical elements already utilized in the known art for switches of large use and therefore it has a reduced cost.

In the present description all possible structural and cinematic alternatives to the embodiments of the invention specifically described have not been illustrated.

These variants however are intended to be included within the protective scope of the present patent, and these alternative embodiments can be easily identified from the description herein made of the relation existing between each alternative embodiment and the result that the invention wishes to achieve.

1. A safety switch, in particular for thermal protection of an electrical apparatus, comprising a container (1) inside which means (2) for activation of said switch is housed, said means comprising a command key (3) and a pair (4, 5) of contact carriers, movable relative to each other, each of them being connected with a terminal of its own of an electric circuit, at least one of said contact carriers (4) being susceptible of oscillation around an oscillation axis (O-O) between two positions, an open position at which said contact carriers are separated from each other and respectively a closed position, at which said contact carriers are in mutual contact, each of said positions being imposed by a corresponding position of said command key, said switch being characterized in that said activation means (2) comprises a device (6) responsive to temperature variations in the environment to be controlled, adapted to act on the electric supply circuit of said apparatus depending on the perceived heat level and carrying out a single action on said circuit, the possibility of reuse of the device after each action being bound to the intervention of an operator.

2. The safety switch as claimed in claim 1, wherein said device (6) comprises an element (61) that is alternately and elastically movable between an active position and a passive position, of non interference and interference respectively with at least one of said activation means (3, 4 and 5), said element (61) being held in said active position by locking means (65) responsive to temperature variations, adapted to free said element (61) taking it to a passive position and locking it to said position, by effect of a predetermined temperature variation, said element (61) in said passive position locking said activation means (3 and/or 4 and/or 5) in one of said open or closed positions of said contact carriers.

3. The safety switch as claimed in claim 2, wherein said element (61) comprises a tubular case (62) rigidly connected with said container, inside which a hollow rod (63) is inserted which is freely slidable in both ways between a contracted position and an extracted position, in said cavity being contained a spring (64) adapted to cause an at least partial extraction of said rod from said case towards said activation means.

4. The safety switch as claimed in claim 2, wherein said locking means (65) comprises a thermocouple (66) rigidly connected with said case and a stop pawl (68) associated with said thermocouple and adapted to be inserted into a corresponding notch (69) formed in the side surface of said rod, when said rod is in said contracted position.

5. The safety switch as claimed in claim 4, wherein said notch (69) comprises a continuous annular throat formed in said side surface.

6. The safety switch as claimed in claim 4, wherein said thermocouple (66) has an elongated lamelliform shape integral with said case at one end and extended along the side surface of said rod, the opposite end of the laminar portion (67) being bent at an angle against said surface so as to form said stop pawl (68).

7. The safety switch as claimed in claim 3, inside which a command key (2) is houses which has a T-shaped configuration with its arms extending in a longitudinal direction and the leg extended in a radial direction, which key rotates in a longitudinal direction in the two ways around a transverse rotation axis R-R, passing through the “T” leg, a spring being fitted in the leg of said “T” and being disposed between said arms and said oscillating contact carrier (4), so as to impose an oscillation of said contact carrier as a consequence of a rotation of said key, and vice versa, wherein said rod (63) in a passive position interferes with said arm of said key.

8. The safety switch as claimed in claim 2, wherein in said interference position said contact carriers are mutually separated.

9. The safety switch as claimed in claim 7, wherein the thrust exerted by said spring (64) is stronger than that exerted by said spring (9).

10. The safety switch as claimed in claim 2, wherein said activation means, when said element (6) is in a passive position, activates a signalling and/or alarm device.
